(19) United States
(12) Patent Application Publication
(10) Pub. No.: US 2007/0109643 A1
(43) Pub. Date: May 17, 2007

(54) Method of forming a diffractive device

(76) Inventors: Robert Arthur Lee, Victoria (AU); Lawrence David McCarthy, Victoria (AU); Gerhard Frederick Swiegers, Victoria (AU); Timothy John Davis, Victoria (AU); Gerard Joseph Wilson, Victoria (AU)

Correspondence Address: LADAS & PARRY, 5670 WILSHIRE BOULEVARD, SUITE 2100, LOS ANGELES, CA, 90036-5679, US

(21) Appl. No.: 10/562,306

(22) PCT Filed: Jul. 7, 2004
(86) PCT No.: PCT/AU04/00916

§ 371 Date: Sep. 1, 2006

(30) Foreign Application Priority Data
Jul. 7, 2003 (AU) 2003-903502

(51) Int. Cl. G02B 5/18; G02B 27/44

(52) U.S. Cl. 359/566

(57) ABSTRACT

There is disclosed a method of forming a diffractive authentication device which generates an optically variable image which varies according to the angle of observation. The method comprises the steps of, providing a primary pattern which encodes a latent image, the primary pattern having a plurality of image elements, and providing a corresponding secondary pattern which will decode the primary pattern to allow the latent image to be observed when the primary and secondary patterns are in at least one registration, wherein the secondary pattern is provided by a diffraction grating microstructure having a plurality of each of at least two different types of diffraction elements. The primary pattern is provided such that predetermined image elements of the primary pattern render diffraction effects from predetermined diffraction elements of the diffraction grating microstructure optically ineffective at least at one observation angle when the authentication device is illuminated with a light source to thereby enable the latent image to be observed.

The present application claims priority of Australian provisional patent application 2003903502, the disclosure of which is incorporated herein by reference.

### FIELD OF THE INVENTION

The present invention relates to a diffractive device.

When devices made in accordance with embodiments of the invention are illuminated by a light source, they generate one or more images which are observable within particular ranges of viewing angles around the device. Devices of embodiments of the invention may be used in a number of different applications, and have particular application as anti-forgery security devices on ID documents such as drivers licenses, credit cards, visas, passports and other valuable documents where secure identification of individuals is required in a way that is resistant to counterfeiting by printing, photocopying and computer scanning techniques.

Embodiments of the invention also have particular application as a low cost anti-counterfeiting device for the protection of banknotes, cheques, credit cards and other financial transaction documents such as share certificates.

### BACKGROUND ART

It is to be understood that, if any prior art publication is referred to herein, such reference does not constitute an admission that the publication forms a part of the common general knowledge in the art, in Australia or any other country.

The new series of American Express US dollar travellers cheques, first issued in 1997, employed as an anti-counterfeiting feature a diffraction grating foil image of the American Express Centurion logo. When illuminated by a light source and the diffraction grating foil device is observed from different viewing angles, the Centurion image appears to switch to an American Express box logo image. This optical variability of the device ensures that it is impossible to copy by normal photocopier or camera techniques.

Diffraction grating devices which exhibit this variable optical behaviour are referred to as optically variable devices (OVDs) and their use as an anti-counterfeiting measure to protect valuable documents is continuing to grow. Examples of particular proprietary optically variable devices and applications to date include the EXELGRAM™ device used to protect the new series of Hungarian banknotes, American Express US dollar and Euro travellers cheques and the Ukrainian visa, and the KINEGRAM™ device used to protect the current series of Swiss banknotes and low denomination Euro banknotes. The EXELGRAM™ device is described in U.S. Pat. No. 5,825,547 and 6,088,161 while the KINEGRAM™ device is described in European patents EP 330,738 and EP 105099.

The KINEGRAM™ and EXELGRAM™ devices are examples of foil based diffractive structures that have proven to be highly effective deterrents to the counterfeiting of official documents. This class of optically diffractive anti-counterfeiting devices also includes the PIXELGRAM™ device that is described in European patent number EP 0 490 923 B1 and U.S. Pat. No. 5,428,479. PIXELGRAM™ devices are manufactured by producing a counterpart diffractive structure wherein the greyness values of each pixel of an optically invariable image are mapped to corresponding small diffractive pixel regions on the PIXELGRAM™ device.

In spite of their industrial effectiveness, these foil based diffractive optically variable devices have a particular deficiency for low volume applications and for one-off applications requiring secure identification of the images of individuals such as for the case of passport or drivers license photographs or identification (ID) card images.

At the present time techniques for protecting an individual portrait image on an ID document include the origination of an OVD image specific to that individual, covering the photograph of the person with a transparent OVD laminate or film or including a standard OVD image on the ID document in an adjacent area of the document. In the first case the process is extremely expensive and time consuming because of the need to produce a new OVD origination for each individual and then produce a hot stamping foil image by embossing techniques. As the cost of OVD originations for security purposes varies from US$5,000 to US$50,000, depending on the technology type and level of security required, the use of individual specific OVD originations for ID applications is not viable for cost reasons alone.

Generally speaking, the high cost of OVD originations means that this type of anti-counterfeiting technology is only suited to mass production applications where the cost of the origination can be amortized over a large production run of identical hot stamping foils. The use of transparent OVD overlay films and the use of a generic OVD image are methods currently employed for amortizing the OVD origination cost over a foil production run for ID applications. However, in these cases the transparent overlay film or OVD image is not specific to the individual and therefore there is a risk that a substitute or counterfeit document could be produced by peeling back the transparent film and replacing the original photographic image by a substitute image to allow a different individual the use of the ID document.

Another technique which has been developed for security of applications is known as Screen Angle Modulation, “SAM”, or its micro-equivalent, “μ-SAM”, is described in detail in U.S. Pat. No. 5,374,976 and by Sybrand Spannenberg in Chapter 8 of the book “Optical Document Security, Second Edition” (Editor: Rudolph L. van Renesse, Artech House, London, 1998, pages 169-199). In this technique, latent images are created within a pattern of periodically arranged, miniature short-line segments by modulating their angles relative to each other, either continuously or in a clipped fashion. While the pattern appears as a uniformly intermediate colour or grey-scale when viewed macroscopically, a latent image is observed when it is overlaid with an identical, non-modulated pattern on a transparent substrate.

As noted above, these techniques involve overlaying a modulated array with the corresponding unmodulated array, or vice versa, in order to reveal the latent image.

The modulated and unmodulated arrays of this technique are usually produced by printing techniques. For this reason, this technique is not as secure as a diffractive OVD because it is more easily reverse engineered than the much smaller scale microstructures of a diffractive OVD.

### SUMMARY OF THE INVENTION

In a first broad aspect, the invention relates to a method of forming a diffractive authentication device which generates an optically variable image which varies according to the angle of observation, the method comprising the steps of:
providing a primary pattern which encodes a latent image, the primary pattern having a plurality of image elements; and
providing a corresponding secondary pattern which will decode the primary pattern to allow the latent image to be observed when the primary and secondary patterns are in at least one registration, wherein the secondary pattern is provided by a diffraction grating microstructure having a plurality of each of at least two different types of diffraction elements, and
wherein the primary pattern is provided such that predetermined image elements of the primary pattern render diffraction effects from predetermined diffraction elements of the diffraction grating microstructure optically ineffective at least at one observation angle when the authentication device is illuminated with a light source to thereby enable the latent image to be observed.

In some embodiments, the primary pattern is provided by being overlaid on the secondary pattern.

In other embodiments, the primary pattern is provided by rendering portions of the microstructure optically ineffective. Depending on the embodiment, the microstructure may be rendered optically ineffective by physically removing it (using, for example, laser ablation), or by reducing its contrast to such an extent that it does not diffract strongly.

In still further embodiments, the primary pattern is provided by being printed on top of a background microstructure. This may either be by printing on a foil surface or by printing on a photosensitive layer.

The two types of diffraction grating regions will typically be provided in a regular pattern. Typically, the regular pattern is provided by arranging at least two types of diffraction grating regions into either pixellated or track-like diffraction grating regions. An example of pixellated diffraction grating regions is a checkerboard pattern, where a plurality of two different types of diffraction grating regions are arranged in a rectangular array so that they alternate in each of the horizontal and vertical axes.

The method may include producing the diffraction grating microstructure by electron beam lithography or laser beam interference fabrication techniques.

Herein, the diffraction grating microstructure is rendered “optically ineffective” in the sense that diffraction effects from these pre-selected regions are either eliminated or greatly reduced in terms of the intensity of the diffracted light from these regions relative to the other regions of the diffraction grating microstructure.

In an embodiment, where the primary pattern is provided by being overlaid on the secondary pattern, the primary pattern is provided upon a transparent substrate, and the secondary pattern is provided in the form of a foil-based diffractive Optical Variable Device (OVD) and the method involves aligning the primary pattern with the OVD Secondary pattern in correct register such that the image elements of the latent image encoded in the primary pattern is observable as having different visual values at certain viewing angles when illuminated with a light source. Depending on the embodiment, the image elements of the primary pattern may be transparent and opaque, or coloured image elements. The image elements may or may not be locally periodic. Accordingly, the different visual values may either be different colours or different shades of grey.

In this embodiment, the OVD foil may be encoded to produce a secure generic optical variability effect and the overlay primary pattern is encoded with image information specific to a particular latent image in such a way that the latent image disappears upon delamination of the film from the document. This technique greatly enhances ID security over present OVD lamination techniques because neither the OVD foil nor the encoded overlay screen are open to modification using current photographic or printing techniques.

In embodiments of the invention where the primary pattern is provided by ablation, the primary pattern is directly incorporated into the OVD foil by laser or other ablation of the diffraction grating microstructure at selected locations within the OVD area determined by the primary pattern. This embodiment of the invention improves both the durability and security of the ID image as there is no possibility of erasing the encoded image information from the surface of the foil.

In an embodiment of the invention where the primary pattern is printed, the primary pattern encoded image information is directly printed on top of the generic OVD foil thereby providing increased security by preventing reverse engineering of the foil and overlay screen interface by delamination.

In a still further alternative embodiment of the invention the encoded image information is made a part of the OVD foil by incorporation of a photosensitive polymer layer above the metallised secondary pattern in the mass-produced foil. The primary pattern is then printed, on a one-off basis, by selective irradiation of the photosensitive layer.

A number of techniques may be used to produce appropriate primary and secondary patterns. These techniques share the feature of producing a modulated array of image elements which encodes a latent image (the “primary” pattern) and a corresponding unmodulated array of image elements (the “secondary” pattern) which will decode the latent image when in register with the unmodulated array. As both the modulated and unmodulated arrays are divided into a plurality of discrete image elements, it is appropriate to refer to the modulated and unmodulated arrays as “digital” images. Accordingly, techniques of this type are collectively referred to herein as “modulated digital images” (MDI). Examples of suitable MDI techniques include SAM, μ-SAM, as well as PHASEGRAM, BINAGRAM, and TONAGRAM.

PHASEGRAMS are described in Australian Provisional patent application no. 2003905861 entitled “Method of Encoding a Latent Image”, filed 24 Oct. 2003 for which a PCT application was filed on 7 Jul. 2004 entitled “Method of encoding a latent image”. In this technique, an image is encoded within a locally periodic pattern by selectively modulating the periodicity of the pattern. When overlaid upon or overlaid with the original pattern on a transparent substrate, the latent image or various shades of its negative becomes visible to an observer depending on the exactness of the registration.

BINAGRAMS are described in International Patent application no. PCT/AU2004/00746 entitled: “Method of Encoding a Latent Image”, filed 4 Jun. 2004. In this technique, an image is divided into pairs of adjacent or nearby pixels, which may be locally periodic or not. One of the pixels in each pair is then selectively modulated to the complementary grey-scale or colour characteristic. When overlaid upon or overlaid with an equivalent non-modulated pattern on a transparent substrate, the latent image or its negative becomes visible depending on the extent of registration.

The primary pattern, as defined in this specification will typically be a modulated version of the Secondary pattern. The primary pattern encodes or incorporates a latent image or images; these are revealed only when the primary pattern is overlaid upon the corresponding Secondary pattern (in the form of an OVD in embodiments of the present invention). The image elements employed in the primary pattern are typically pixels (i.e. the smallest available picture element). Typically, the primary pattern will be rectangular and hence its image elements will be organised in a rectangular array. However, the image elements may be arranged in other ways. Image elements will typically be arrayed in a periodic fashion, such as alternating down one column or one row, since this allows the Secondary pattern to be most easily registered with the primary pattern in overlay. However random or scrambled arrangements of image elements may be used.

In this specification, the term “secondary pattern” is used in two contexts, either describing a pattern which will decode a primary pattern when overlying or overlaid by the primary pattern (depending on the nature of the primary pattern) or to describe such a secondary pattern as applied to a microstructure. When the secondary pattern is applied to form a diffraction grating microstructure as described in this specification, the secondary pattern consists of diffraction elements which correspond to the image elements which either effectively diffract light (“on” diffraction elements) or diffract light ineffectively (“off” diffraction elements) at a particular angle of observation. These diffraction elements are arrayed in the pattern of the Secondary pattern which also corresponds to the primary pattern employed to encode the latent image. The physical dimensions of the diffraction elements in the physical Secondary pattern are, moreover, substantially identical to those of the image elements of a Secondary pattern image which corresponds to the primary pattern employed. The “on” and “off” diffraction elements are arrayed in such a way that when illuminated with a light source, they contrast image elements within the primary pattern that reveal the latent image, or an image related thereto. The optical variability of the device is achieved when the angle of view is changed to other specific angles of view and all of the “off” diffraction element convert to “on” pixels and vice versa. To achieve the required contrast it is necessary that all of the “on” diffraction element at any specific angle of observation must diffract light, while all of the “off” pixels do not diffract light at this angle.

The secondary pattern will typically be a regular array of “on” and “off” diffraction elements. For example, a secondary pattern may be a rectangular array consisting of track-like diffraction grating regions; that is, a plurality of vertical lines of “on” diffraction elements, each line being 1 diffraction element wide and separated by identically wide vertical lines of “off” diffraction elements. Another typical secondary pattern may be a checkerboard of “on” and “off” diffraction elements. Random and scrambled arrays may, however, also be used, so long as the “on” diffraction elements in the secondary pattern are capable, when in correct register, of contrasting all of the image elements in the primary pattern which reveal the latent image and none of the remaining pixels.

When the secondary pattern is applied to a microstructure it is also referred to in the present specification as the “background OVD microstructure” or the “background OVD”.

Another technique which may be used to create a primary pattern from a secondary pattern is known as TONAGRAM and described in Australian Provisional Patent application 2004900187 entitled “Method of Concealing an Image” filed 17 Jan. 2004.

In this technique, an MDI, such as a BINAGRAM or a PHASEGRAM is mathematically combined with an overt image, such as a photographic portrait, to thereby render a primary pattern which contains both the overt image and one or more concealed latent images. When overlaid with the corresponding secondary pattern, the latent images are revealed. In the same way, a secondary pattern consisting of a diffractive structure of the type described in this application may be overlaid with a printed TONAGRAM primary pattern, thereby rendering an OVD containing an overt image which is visible at all angles of observation and which contains one or more latent images which are visible only at selected angles of observation. Alternatively, the blank canvas diffractive structure which serves as the secondary pattern may be rendered optically ineffective in selected areas according to a TONAGRAM algorithm. An OVD containing an overt image which is visible at all angles of observation and which contains one or more latent images which are visible only at selected angles of observation is thereby created.

The invention also extends to a diffractive device such as a diffractive authentication device or a novelty item produced by the foregoing method as well as to documents or instruments incorporating such a diffractive device.

In another broad aspect, the invention relates to a diffractive device which generates an optically variable image which varies according to the angle of observation, the diffractive device comprising:
a primary pattern which encodes a latent image, the primary pattern having a plurality of image elements; and
a corresponding secondary pattern which will decode the primary pattern to allow the latent image to be observed when the primary and secondary patterns are in at least one registration, wherein the secondary pattern is provided by a diffraction grating microstructure having a plurality of each of at least two different types of diffraction elements, and
wherein the primary pattern is provided such that the predetermined image elements of the primary pattern render diffraction effects from predetermined diffraction elements of the diffraction grating microstructure optically ineffective at least at one observation angle when the authentication device is illuminated with a light source to thereby enable the latent image to be observed.

As outlined above, a foil-based OVD, patterned in the arrangement of a MDI Secondary pattern, but using two types of diffraction grating rulings in place of a printed MDI pattern, can be masked by the corresponding MDI primary pattern to generate an MDI latent image, for example, in the form of a unique, multi-coloured OVD effect. The resulting hybrid OVD-MDI, referred to here as an ID-OVD (or “VOID”), displays optically variable properties which are difficult to counterfeit, but is nevertheless easily customised because the primary pattern can be readily printed and the OVD-based Secondary pattern can be mass produced in a generic form.

Embodiments of the present invention therefore provide a more general and useful approach to the protection of portrait images on security documents by separating the optically variable and identification aspects of the portrait image in such way that the two aspects can be manufactured separately and recombined in an overlay manner. Certain embodiments of the present invention incorporate the OVD protection into a generic type of diffracting OVD foil which is hot-stamped onto a document to be protected and this foil is then overlaid either with a transparent film containing the encoded ID information or printed in register with the ID information pattern. The combination of these two effects reveals the encoded portrait as a latent image displaying OVD effects.

In particular embodiments, the invention disclosed herein makes use of the low cost individual portrait generating capabilities of the MDI technologies by converting them into a masking pattern which masks a specially designed background diffraction grating canvas in such a manner that a multiplicity of images is generated as the angle of view of the device is changed.

The combination of an MDI type masking screen and the increased security attributes of a specially designed diffractive background canvas provides a low cost means for securing the images of individuals on a one-off basis. In the present specification, securing the image of an individual means preventing the image from being changed by substitution, alteration or copying by photographic, printing or computer scanning techniques.

Thus, devices of the preferred embodiment which combine an MDI and an OVD feature have the advantage that the OVD feature is very difficult to counterfeit, but the MDI feature readily customizes the overall image generated. In particular, mass producing the OVD section in the form of an MDI secondary pattern and overlaying (or otherwise modifying) this with the corresponding MDI primary pattern prospectively allows the preparation of low-cost, personalized OVDs.

Further features of the invention will become apparent from the following description of preferred embodiments of the invention.

### BRIEF DESCRIPTION OF THE DRAWINGS

The preferred embodiments will be described with reference to the accompanying drawing in which:

FIG. 1 depicts a particular arrangement of the background OVD microstructure or secondary pattern;

FIG. 2 shows another arrangement of the background OVD microstructure or secondary pattern;

FIG. 3 shows an example of a primary Pattern corresponding to a particular encoded data file for a particular ID application;

FIG. 4 shows the primary pattern of FIG. 3 added to the background OVD Microstructure (secondary pattern) corresponding to FIG. 2;

FIG. 5 shows the image generated by the overlaid primary and secondary pattern of FIG. 4 observed at a particular angle of view;

FIG. 6 shows the image generated by the overlaid primary and secondary patterns of FIG. 4 observed at another particular angle of view;

FIG. 7 shows an example of a primary pattern;

FIG. 8 shows the primary pattern of FIG. 7 added to the background OVD Microstructure (secondary pattern) corresponding to FIG. 1;

FIG. 9 shows the image generated by the overlaid primary and secondary patterns of FIG. 8 observed at another particular angle of view; and

FIG. 10 shows the image generated by the overlaid primary and secondary screens of FIG. 8 observed at a particular angle of view.

### DESCRIPTION OF THE PREFERRED EMBODIMENTS

Preferred embodiments of the invention will initially be described in relation to the visual effects which can be produced by combining an MDI primary pattern with a secondary pattern in the form of a diffraction grating microstructure. Following this description is a description of some possible techniques for constructing diffractive authentication devices.

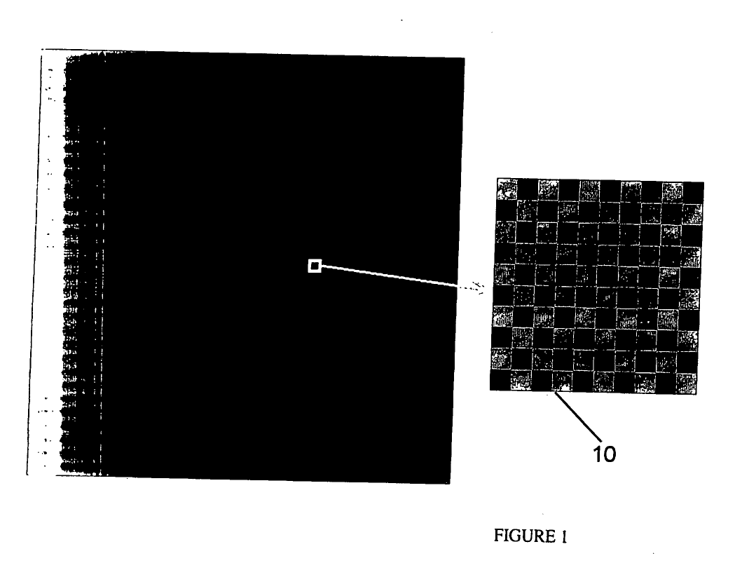

FIG. 1 is an illustrative example of a background OVD microstructure (or secondary pattern). In FIG. 1, the pixel areas having different shades represent two different types of diffraction grating microstructures as best seen in enlarged section 10. For convenience these shades will be referred to as red (the lighter shade) and blue (the darker shade) pixel areas. Typical dimensions of the diffraction grating pixel areas would be 30 microns×30 microns or 60 microns×60 microns. For some applications the dimensions of the pixels may be smaller or larger than these figures depending on the image resolution required for the application.

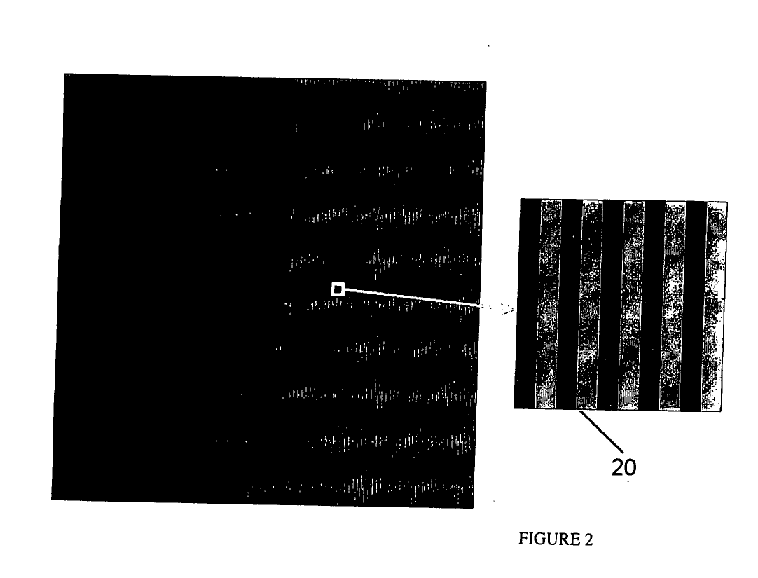

FIG. 2 shows another arrangement of the background OVD microstructure or secondary pattern. In FIG. 2 the red and blue strip or track areas represent two different types of diffraction grating microstructures as best seen in enlarged section 20. Typically the width of the diffraction grating tracks would be 30 microns or 60 microns. For some applications the width of the strips or tracks may be smaller or larger than these figures depending on the image resolution required for the application. The length of the tracks is a function of the image area required for the application and may be 20 mm or longer.

The choice of MDI secondary pattern will depend on the embodiment.

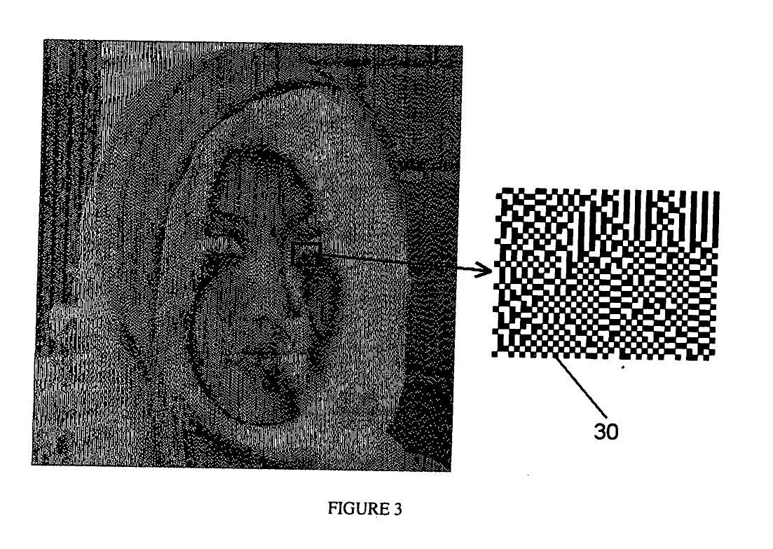

FIG. 3 shows a primary pattern of a first preferred embodiment into which an image has been encoded by modulation of the secondary pattern shown in FIG. 2. The method of forming the modulated digital image (MDI) is that of a BINAGRAM. Enlarged section 30 shows a portion of the image of the left eye of a primary pattern.

In a BINAGRAM, the primary pattern is typically from an original image. In an example where the original image is a photograph, this original image is then dithered into image elements which have one of a set of primary visual characteristics. The primary visual characteristics will be grey-scale values or hues depending on the embodiment. The original elements are then paired, typically with a neighbouring image element. In the example of a preferred embodiment, the image elements are paired such that when overlaid with the corresponding secondary pattern, one element in each pair will correspond to the red track and one will correspond to the blue track. The image elements are then transformed. In a typical transformation, one pixel in each pair will take the average value of the visual characteristics of the pair and the other pixel is allocated a complementary visual characteristic. Thus, one pixel in each pair acts to carry information from the original image while the other disguises the information.

An alternative method of forming the primary pattern is to use a computer graphics program such as Adobe Photoshop to produce both positive tone and negative tone versions of the input image (e.g. a portrait). The positive tone and negative tone images can then be combined into a primary pattern by; firstly filtering the positive tone image with the “on” pixels of the secondary screen (that is removing all pixels from the positive tone image corresponding to the positions of the “off” pixels on the secondary screen) and then converting the resultant filtered positive tone image to a bitmap version by using the dithering option within the computer graphics program; secondly applying the reverse procedure to the negative tone image by filtering the negative tone image with the “off” pixels of the secondary pattern (that is removing all pixels from the negative tone image corresponding to the positions of the “on” pixels on the secondary screen)and then converting the resultant filtered negative tone image to a bitmap version by using the dithering option within the computer graphics program; and finally overlaying the filtered and dithered versions of both the negative tone and positive tone images to obtain the resultant primary pattern version of the input portrait image.

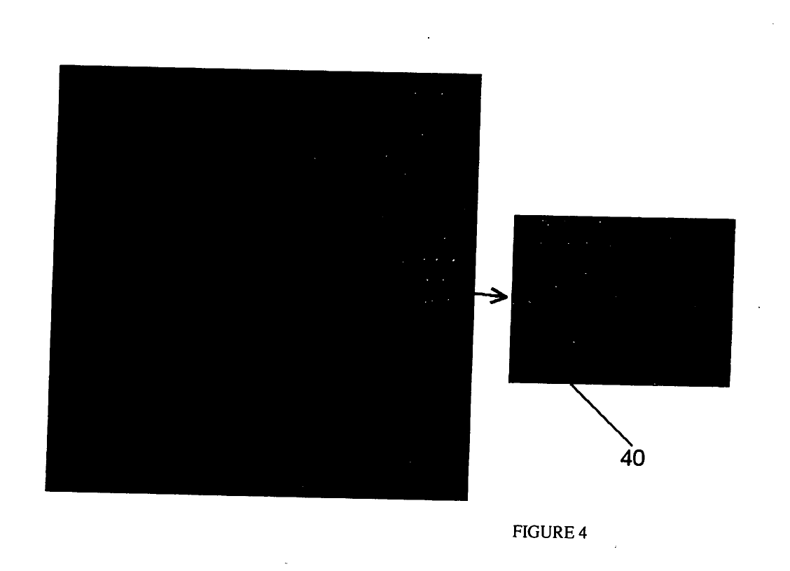

FIG. 4 shows a simple addition of the primary image in FIG. 3 to the secondary pattern in FIG. 2 where the black pixels have been rendered optically ineffective by being erased, the dark grey pixels indicate the original blue pixels which have been retained, and the light grey pixels indicate the original red pixels which have been retained as can best be seen by reference to enlarged section 40.

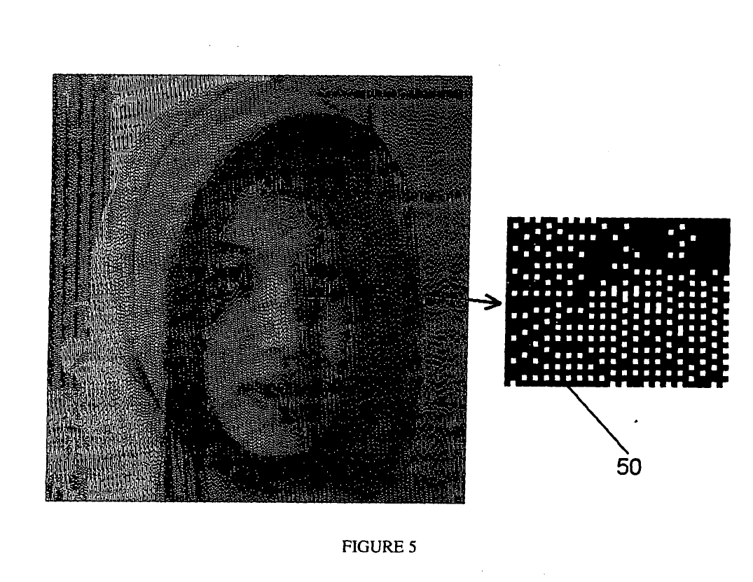

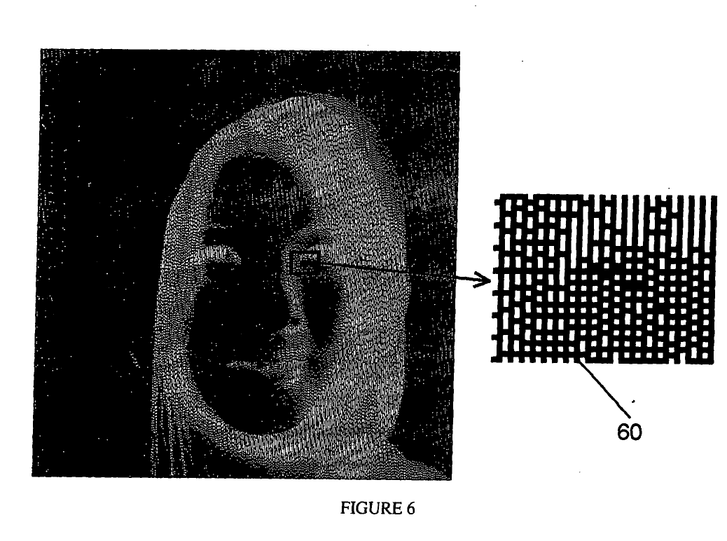

FIG. 5 depicts the image seen by an observer at one particular range of viewing angles with the red OVD tracks “on” and therefore displayed as white for clarity; the blue pixels are “off” at this angle and therefore appear black as best seen in enlarged section 50. FIG. 6 depicts the image seen by an observer at another particular range of viewing angles with the blue tracks “on” and therefore displayed as white for clarity; the red pixels are “off” at this angle and therefore appear black as best seen in enlarged section 60.

FIGS. 5 and 6 demonstrate that an optically variable effect can be generated by printing techniques if the background canvas is comprised of an OVD microstructure consisting of two groups of diffraction grating pixels (that is, the secondary pattern). The OVD effect shown in these figures corresponds to a switch of a portrait image from positive tone to negative tone as the angle of view is changed.

This principle of using a background OVD canvas to convert a printed image into optically variable form can be extended to the case of two-channel OVD images. An example of such a process is now described.

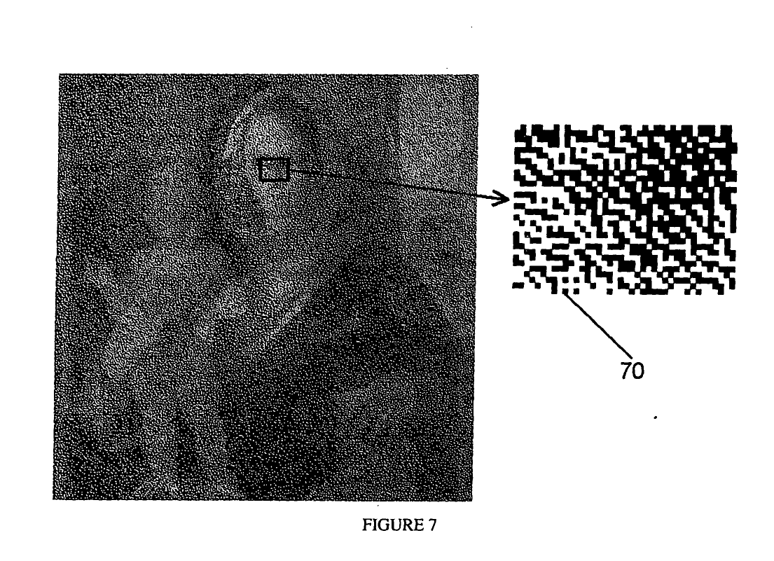

FIG. 7 depicts a primary pattern consisting of a two-channel image—i.e. a primary pattern which encodes two images. In this case, the primary pattern is a modulated form of the secondary pattern shown in FIG. 1 and encodes two separate latent images. Enlarged portion 70 shows a detail of where the two faces of the images overlap.

A primary pattern corresponding to a two channel image can also be prepared using a computer graphics program such as Adobe Photoshop. Two input images can be combined into a primary pattern by; firstly filtering the first image with the “on” pixels of the secondary screen (that is removing all pixels from the first image corresponding to the positions of the “off” pixels on the secondary screen) and then converting the resultant first image to a bitmap version by using the dithering option within the computer graphics program; secondly applying the reverse procedure to the second image by filtering the second image with the “off” pixels of the secondary pattern (that is removing all pixels from the second image corresponding to the positions of the “on” pixels on the secondary screen)and then converting the resultant filtered second image to a bitmap version by using the dithering option within the computer graphics program; and finally overlaying the filtered and dithered versions of both the first and second images to obtain the resultant two channel primary pattern corresponding to the two input images.

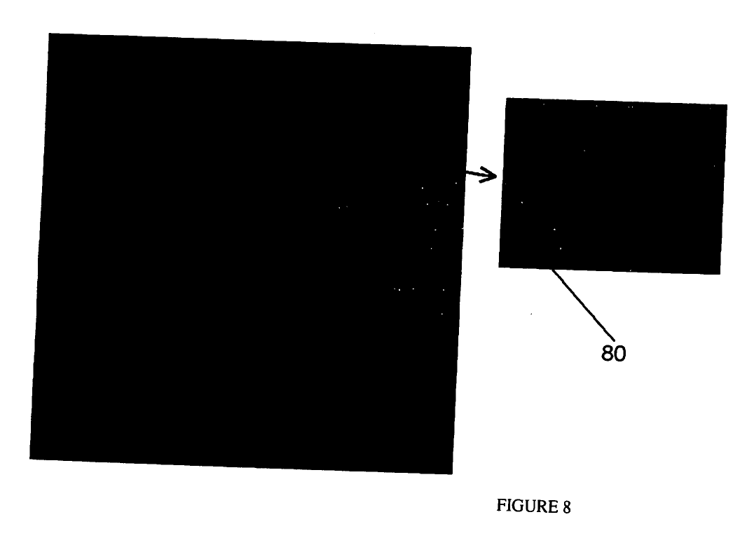

FIG. 8 illustrates an addition of FIG. 7 and FIG. 1 where the black pixels have been rendered optically ineffective by being erased, the dark grey pixels indicate the original blue pixels which have been retained, and the light grey pixels indicate the original red pixels which have been retained as best seen by reference to enlarged portion 80.

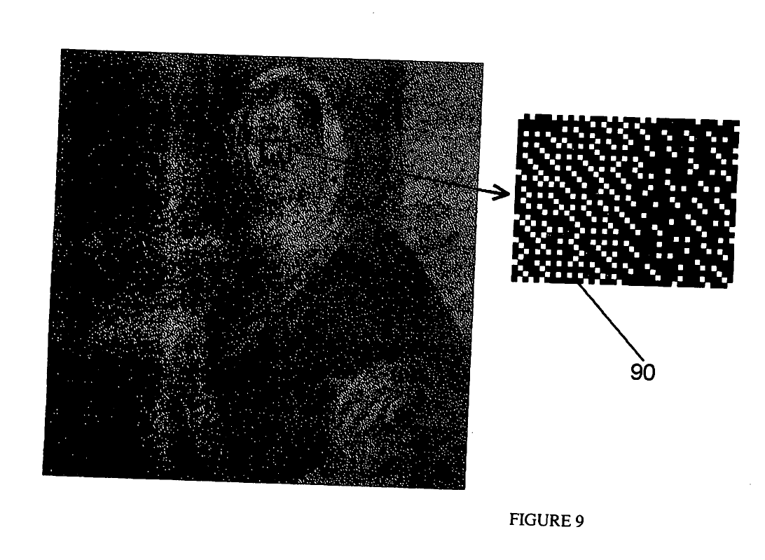

FIG. 9 depicts the image seen by an observer at one particular range of viewing angles with the red OVD pixels “on” and therefore displayed as white for better clarity; the blue pixels are “off” at this angle and therefore appear black as shown in enlarged portion 90.

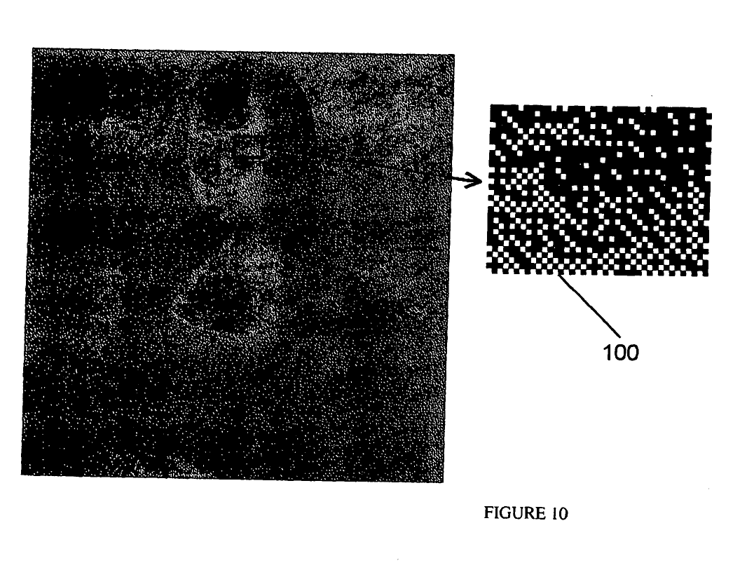

FIG. 10 depicts the image seen by an observer at another particular range of viewing angles with the blue tracks. “on” and therefore displayed as white for better clarity; the red pixels are “off” at this angle and therefore appear black as shown in enlarged portion 100.

FIGS. 9 and 10 confirm that a two channel optically variable effect can also be generated by printing techniques if the background canvas is comprised of an OVD microstructure consisting of two groups of diffraction grating pixels (that is, the secondary pattern). The OVD effect shown in these figures corresponds to a switch from one positive tone portrait image to another positive tone portrait image as the angle of view is changed.

The examples shown in FIGS. 1 to 10 are intended to illustrate two particular embodiments of the new invention. Many other embodiments of the invention are possible and the generality of these applications makes the invention particularly suited to the areas of identity verification for ID documents and also for the authentication of banknotes, cheques and other financial transaction documents which suffer from a risk of counterfeiting by printing, computer scanning, and colour copying techniques.

A further embodiment of the invention can be realised by recognising that the two channel mechanism described above allows for the possibility of encoding data in an individual manner by using bar code patterns for the images in the two channels. The result will be in the form of a diffraction bar code with the first bar code pattern able to be read by a laser at a first angle of view and the second and different bar code pattern read at a second angle of view. The security and integrity of the data is ensured by a software correlation process involving the two bar code components. Writing of the data is achieved by a printing process involving the interlacing of the two bar codes on a diffraction grating background in the form of an interlacing of diffraction grating tracks of two different groove periodicities.

The concepts described above can also be extended to include the case of a two channel image where the image in one channel is a generic image fixed at the time of fabricating the secondary pattern microstructure. The second channel image is then constructed by using a computer graphics program to create a primary pattern that can be individualised at the point of use of the device. An example of this type of application would be a passport application. In the case of an Australian passport the generic image could be the Coat of Arms of Australia and the second channel image would be a portrait image of the passport holder and the foil device could be incorporated into the data page of the passport. As the angle of view of the data page is changed the image generated by the authentication device would change from an image of the passport holder to the Coat of Arms thereby securely confirming that the passport holder is a citizen of Australia.

Where the secondary pattern is as shown in FIG. 2, a primary pattern may be produced according to a process whereby a positive tone version of an original image is sliced or fractured into a multiplicity of strips or tracks, and every odd numbered track is removed, and then a semi-transparent version of the result is created by binary dithering or sampling techniques and the resultant sliced and binary dithered version of the positive tone image is overlaid by a second sliced and binary dithered image based on a negative tone image of the subject where in this case every even numbered track of the negative tone image is removed to allow these areas to be occupied by the corresponding binary dithered tracks of the positive tone image of the subject.

In a two-channel case, the primary pattern may be produced according to a process whereby a positive tone version of a first original image is sliced or fractured into a multiplicity of strips or tracks, and every odd numbered track is removed, and then a semi-transparent version of the result is created by binary dithering or sampling techniques and the resultant sliced and binary dithered version of this first image is overlaid by a second sliced and binary dithered positive tone image based on a second original image. Wherein for the second original image every even numbered track of this second image is removed to allow these areas to be occupied by the corresponding binary dithered tracks of the first original image.

In addition to the BINAGRAM technique described above, and of which further details may be found in International patent application PCT/AU2004/00746 entitled “Method of Encoding a Latent Image” filed 4 Jun. 2004 the disclosure of which is incorporated herein by reference. A number of other techniques may be used to produce an appropriate primary pattern.

The primary pattern may be produced according to the technique, known as “SAM” or “μ-SAM”, as described in U.S. Pat. No. 5,374,976 which is incorporated herein by reference and by Sybrand Spannenberg in Chapter 8 of the book “Optical Document Security, Second Edition” (Editor: Rudolph L. van Renesse, Artech House, London, 1998, pages 169-199), or according to the technique known as PHASEGRAM (Australian Provisional patent entitled “Method of Encoding a Latent Image”, Australian Provisional Patent number 2002952220 (24 Oct. 2003) for which an International application was filed by the present applicant on 7 Jul. 2004, the disclosure of which is incorporated herein by reference.

In this technique, an image is encoded within a locally periodic pattern by selectively modulating the periodicity of the pattern. When overlaid upon or overlaid with the original pattern on a transparent substrate, the latent image or various shades of its negative becomes visible to an observer depending on the exactness of the registration.

The periodicity of the image is modulated by phase-shifting image elements to create an encoded image. That is, different displacements are applied to image elements depending upon a value of a visual characteristic (e.g. a grey-scale value or a hue). A PHASEGRAM embodiment will typically utilise a secondary pattern where the diffraction elements are arrayed in columns of alternating types of diffraction elements N diffraction elements wide. This allows N+1 visual characteristic values to be encoded.

A latent image (the image which it is desired to be able to view) is formed by taking an original image and separating it into image elements which only take one of the set of allowable values of the visual characteristic. The latent image is then related to a preliminary primary pattern which has image elements corresponding to those of the secondary pattern. The image elements of the primary pattern are then displaced in accordance with their relationship with the value of the visual characteristic of the latent image elements with which they are related to form a final primary pattern which encodes the latent image.

Various different displacement schemes can be used. An example, is one where there are M shades or hues and image elements related to a first shade or hue are displaced by one image element (e.g. a distance corresponding to the width of a diffraction element), the second shade or hue is displaced by two image elements etc. with the M^{th} shade or hue displaced by M image elements.

Another technique which may be used to create a primary pattern from a secondary pattern is known as TONAGRAM and described in Australian Provisional Patent application 2004900187 entitled “Method of Concealing an Image” filed 17 Jan. 2004, which is incorporated herein by reference.

In this technique, an MDI, such as a BINAGRAM or a PHASEGRAM is mathematically combined with an overt image, such as a photographic portrait, to thereby render a primary pattern which contains both the overt image and one or more concealed latent images. When overlaid with the corresponding secondary pattern, the latent images are revealed. In the same way, a secondary pattern consisting of a diffractive structure of the type described in this application may be overlaid with a printed TONAGRAM primary pattern, thereby rendering an OVD containing an overt image which is visible at all angles of observation and which contains one or more latent images which are visible only at selected angles of observation. Alternatively, the blank canvas diffractive structure which serves as the secondary pattern may be rendered optically ineffective in selected areas according to a TONAGRAM algorithm. An OVD containing an overt image which is visible at all angles of observation and which contains one or more latent images which are visible only at selected angles of observation is thereby created.

In a two-channel case, where the secondary pattern is as shown in FIG. 1, the primary pattern may be produced according to a process whereby a positive tone version of a first original image is fractured into a checkerboard pattern, and every alternate cell of the checkerboard (e.g. every “black” cell) is removed, and then a semi-transparent version of the image remainder is created by binary dithering or sampling techniques and the resultant fractured binary dithered version of the first positive tone image is overlaid by a second checkerboard fractured binary dithered image based on a second original positive tone image wherein for the second image every inverse fractured checkerboard cell (e.g. every “white” cell) of the second image is removed to allow these areas to be occupied by the corresponding binary dithered (“black”) cells of the first image subject.

A further alternative two-channel technique may involve encoding two or more separate but identical latent images which are observable at two slightly offset observation angles. The offset being chosen such that when observed by a human observer at an appropriate distance from the image surface, a stereoscopic effect allows the observer to perceive a three-dimensional image.

Thus in a further embodiment, it is possible to create a mask (e.g. a primary pattern) which encodes two or more identical images in such a manner that they are observable at offset observation angles when the mask overlays an appropriate secondary pattern, such as the secondary patterns disclosed herein.

Persons skilled in the art will appreciate that various different techniques may be used to produce authentication devices in accordance with this method. For example, the diffraction grating microstructure or “background OVD microstructure” can be formed either by electron beam lithography or laser interference fabrication technique. The microstructure will typically be formed on a thin aluminium foil.

The primary pattern can then be combined with the secondary pattern—i.e. the background diffraction microstructure in a number of different ways. For example, the primary pattern can be printed on an otherwise transparent polymer substrate which is overlaid and adhered to the foil. The transparent substrate being overlaid such that it is in appropriate registration with the background microstructure such that the latent image will be visible at predetermined angles of observation.

Alternatively, the primary pattern may be printed on top of the background microstructure. For example, the image may be printed directly on top of the foil. Alternatively, a photosensitive layer may be incorporated in the mass produced foil and irradiated to produce the appropriate primary pattern.

In a still further embodiment, laser or other ablation of selected regions of the background microstructure may be used to render these regions optically ineffective. That is so these regions are non-diffractive or greatly reduced in the intensity of the diffracted light.

Persons skilled in the art will appreciate that there are other possible techniques for providing the primary pattern such as to render the background diffractive microstructure optically ineffective in such locations as are required to encode the latent image.

In all of the MDI techniques described above, it is generally desirable that each track or strip have a width greater than 1 microns and that at least one strip or track is greater than 1 mm in length.

Where a checkerboard pattern is used, it is desirable that each image element has an edge length greater than 1 microns.

The diffraction grating may be formed in accordance with any known technique, however it is generally desirable that within each diffraction grating region the grating grooves are modulated or varied in shape, spacing and/or curvature or slope.

It is also generally desirable that the modulation of the diffraction grating grooves within each diffraction grating region is designed to maximise the diffraction efficiency of the first order diffracted beams from these regions and further that the modulation of the diffraction grating grooves within each diffraction grating region is described in terms of groove patterns of fixed spatial frequency, but variable groove curvature or groove angle throughout each region.

It is also preferred that the diffraction grating grooves within one group of diffraction grating regions is arranged to lie at right angles to the grooves of a second group of diffraction grating regions.

Further variations will be apparent to persons skilled in the art. For example, the background microstructure may also include optically variable effects that are generic in nature and non-specific to the person, object or design that is being authenticated by the diffractive authentication device.

The microstructure of the device may also incorporate extremely small scale images of size less than 60 microns in width, which can be used to provide a higher degree of authentication or security by means of microscopic examination of the microstructure

Further details as to how to construct appropriate diffraction grating microstructures may be obtained by reference to U.S. Pat. No. 5,825,547, U.S. Pat. No. 6,008,161, U.S. Pat. No. 5,428,479, EP 330,738, EP 105099 and EP 0 490 923 which are referred to in the Background to the Invention portion of this specification.

Persons skilled in the art will appreciate that various modifications can be made to the present invention without departing from the scope of the invention. These and other modifications will be apparent to those skilled in the art.

1. A method of forming a diffractive authentication device which generates an optically variable image which varies according to the angle of observation, the method comprising the steps of:
providing a primary pattern which encodes a latent image, the primary pattern having a plurality of image elements; and
providing a corresponding secondary pattern which will decode the primary pattern to allow the latent image to be observed when the primary and secondary patterns are in at least one registration, wherein the secondary pattern is provided by a diffraction grating microstructure having a plurality of each of at least two different types of diffraction elements,
wherein the primary pattern is provided such that predetermined image elements of the primary pattern render diffraction effects from predetermined diffraction elements of the diffraction grating microstructure optically ineffective at least at one observation angle when the authentication device is illuminated with a light source to thereby enable the latent image to be observed.

2. A method as claimed in claim 1, comprising overlaying the primary pattern on the secondary pattern.

3. A method as claimed in claim 1, comprising rendering portions of the microstructure optically ineffective to form the primary pattern.

4. A method as claimed in claim 1, comprising printing the primary pattern on top of a background microstructure.

5. A method as claimed in claim 4, comprising printing said primary pattern on a foil surface.

6. A method as claimed in claim 4, comprising printing said primary pattern on a photosensitive layer overlying said microstructure.

7. A method as claimed in claim 1, comprising providing said at least two types of diffraction grating regions in a regular pattern.

8. A method as claimed in claim 7, comprising arranging said at least two types of diffraction grating regions into pixellated diffraction grating regions.

9. A method as claimed in claim 7, comprising arranging said at least two diffraction grating regions into track-like diffraction grating regions.

10. A method as claimed in claim 8, comprising arranging a plurality of two different types of diffraction grating regions in a rectangular array so that they alternate in each of the horizontal and vertical axes.

11. A method as claimed in claim 1, comprising producing the diffraction grating microstructure by electron beam lithography.

12. A method as claimed in claim 1, comprising producing the diffraction grating microstructure by laser beam interference.

13. A method as claimed in claim 2, comprising providing the primary pattern upon a transparent substrate, providing the secondary pattern in the form of a foil-based diffractive optical variable device (OVD), and aligning the primary pattern with the OVD Secondary pattern in correct register such that the image elements of the latent image encoded in the primary pattern is observable as having different visual values at certain viewing angles when illuminated with a light source.

14. A method as claimed in claim 2, comprising providing an OVD foil encoded with a secure generic optical variability effect, overlaying a primary pattern encoded with image information specific to a particular latent image in such a way that the latent image disappears upon delamination of the film from the document.

15. A method as claimed in claim 3, comprising ablating the diffraction grating microstructure at selected locations within the OVD area corresponding to the primary pattern.

16. A method as claimed in claim 1, comprising producing said primary pattern using a modulated digital image technique.

17. A method as claimed in claim 16, comprising selecting said technique from the group of SAM, μ-SAM, PHASEGRAM, TONAGRAM and a BINAGRAM.

18. A diffractive device which generates an optically variable image which varies according to the angle of observation, the diffractive device comprising:
a primary pattern which encodes a latent image, the primary pattern having a plurality of image elements; and
a corresponding secondary pattern which will decode the primary pattern to allow the latent image to be observed when the primary and secondary patterns are in at least one registration, wherein the secondary pattern is provided by a diffraction grating microstructure having a plurality of each of at least two different types of diffraction elements, and
wherein the primary pattern is provided such that the predetermined image elements of the primary pattern render diffraction effects from predetermined diffraction elements of the diffraction grating microstructure optically ineffective at least at one observation angle when the authentication device is illuminated with a light source to thereby enable the latent image to be observed.

19. A diffractive device as claimed in claim 18, wherein said primary pattern is overlaid on the secondary pattern.

20. A diffractive device as claimed in claim 18, wherein the primary pattern is provided by rendering portions of the microstructure optically ineffective.

21. A diffractive device as claimed in claim 18, wherein said primary pattern is provided by being printed on top of a background microstructure.

22. A diffractive device as claimed in claim 18, wherein said at least two types of diffraction grating regions form a regular pattern.

23. A diffractive device as claimed in claim 22, wherein said regular pattern is a pixellated pattern.

24. A diffractive device as claimed in claim 22, wherein said regular pattern is a track-like pattern of diffraction grating regions.

25. A diffractive device as claimed in claim 23, wherein a plurality of two different types of diffraction grating regions are arranged in a rectangular array so that they alternate in each of the horizontal and vertical axes to thereby form a checkerboard pattern.

26. A diffractive device as claimed in claim 18, comprising two different types of diffraction elements.

27. A diffractive device as claimed in claim 19, wherein the primary pattern is provided upon a transparent substrate, and the secondary pattern is provided in the form of a foil-based diffractive Optical Variable Device (OVD), the primary pattern being aligned with the OVD secondary pattern in correct register such that the image elements of the latent image encoded in the primary pattern are observable as having different visual values at certain viewing angles when illuminated with a light source.

28. A diffractive device as claimed in claim 27, wherein the image elements are transparent and opaque.

29. A diffractive device as claimed in claim 27, wherein the image elements are transparent or coloured

30. A diffractive device as claimed in claim 27, wherein the OVD foil is encoded to produce a secure generic optical variability effect and the overlaid primary pattern is encoded with image information specific to a particular latent image.

31. A diffractive device as claimed in claim 20, wherein the diffraction grating microstructure is ablated at selected locations determined by the primary pattern.

32. A diffractive device as claimed in claim 21, wherein said secondary pattern is formed on an OVD foil.

33. A diffractive device as claimed in claim 32, wherein the primary pattern information is printed on top of said OVD foil.

34. A diffractive device as claimed in claim 23, wherein said OVD foil incorporates a photosensitive layer above a metallised layer which provides the secondary pattern, whereby the primary pattern can be printed by selective irradiation of the photosensitive layer.

35. A diffractive device as claimed in claim 18, wherein said primary pattern comprises a modulated digital image.

36. A diffractive device as claimed in claim 35, wherein said modulated digital image is one of a SAM image, μ-SAM image, a PHASEGRAM, a TONAGRAM or a BINAGRAM.

37. A diffractive device as claimed in claim 18, which constitutes a diffractive authentication device.

38. A diffractive device as claimed in claim 18, which constitutes a novelty item.

39. A document or instrument incorporating a diffractive device as claimed in claim 18.

40. A diffractive device as claimed in claim 18, wherein the primary and secondary patterns are constructed such that a first image is observable at at least a first angle of view and a second image is observed at at least a second angle of view.

41. A diffractive device as claimed in claim 40, wherein said first image is an image of a person.

42. A diffractive device as claimed in claim 41, wherein said second image is an image of a logo, a coat of arms or the like.

43. A diffractive device as claimed in claim 41, wherein said second image encodes data.

44. A diffractive device as claimed in claim 43, wherein said second image is a bar code.

45. A diffractive device as claimed in claim 40, wherein both the first and second images encode data.

46. A diffractive device as claimed in claim 45, wherein both the first and second images are bar codes.
